(19) United States
(12) Patent Application Publication
(10) Pub. No.: US 2013/0017053 A1
(43) Pub. Date: Jan. 17, 2013

(54) Depalletizing Tool

(71) Applicants: Jean-Francois Forget, Montreal (CA); Regis Metivier, Montreal (CA); Sylvain-Paul Morency, Laval (CA); Alexandre Pain, Longueuil (CA)

(72) Inventors: Jean-Francois Forget, Montreal (CA); Regis Metivier, Montreal (CA); Sylvain-Paul Morency, Laval (CA); Alexandre Pain, Longueuil (CA)

(73) Assignee: Axium, Inc., Montreal (CA)

(21) Appl. No.: 13/180,089

(22) Filed: Jul. 11, 2011

(51) Int. Cl. B65G 59/02; B65G 61/00

(52) U.S. Cl. 414/796.9; 414/801

(57) ABSTRACT

A tool and a method for depalletizing piles of objects separated by sheets are described herein. The tool comprises a plate assembly for insertion between the highest pile from the piles of objects and the next separator sheet. The plate assembly has a fixed portion and a tip provided at a distal end thereof and is movable between a detecting position, wherein an upward displacement of the tip is allowed relative to the fixed portion, and a depalletizing position, wherein the tip is immobilized relative to the fixed portion. The tool further comprises a plate sensor for detecting the displacement of the tip relative to the fixed portion and for generating a first detection signal responsive to said displacement, and a pressure assembly that defines a gripper with the plate assembly for receiving the highest pile of objects and for selectively applying pressure thereon. When the plate assembly is in the detecting position, the controller detects one of the separated sheets when the tip is displaced upwardly relative to the fixed portion following a downward movement of the tool.

### BACKGROUND

The present disclosure generally relates to depalletizing methods and tools.

More specifically, the present disclosure relates to depalletizing of piles of objects, such as cartons, separated by sheets.

Depalletizing tools are known in the art that includes a retractable plate extendable to insert itself under a pile to depalletize and retractable to position the pile at another location. Some of these tools include two layers of retractable plates, wherein one of the two plates includes a sensor to detect the presence of a separator sheet.

A drawback of such tools is that they include a retracting mechanism involving the use of rails and additional motors that add complexity and weight to the tool. This in turn adds unnecessary limits to the maximum weight of a pile that can be handled by the tool, in addition to more maintenance to the tool, etc.

An object of the present invention is to provide improved depalletizing methods and tools.

Other objects, advantages and features of the present invention will become more apparent upon reading the following non restrictive description of embodiments thereof, given by way of example only with reference to the accompanying drawings.

### BRIEF DESCRIPTION OF THE DRAWINGS

In the appended drawings:

FIG. 1 is a perspective view of a tool for depalletizing piles of objects separated by sheets according to an embodiment; the tool being illustrated mounted at the end of a robotic arm and adjacent a pallet including piles of cartons to depalletize;

FIG. 2 is a top perspective view of the tool from FIG. 1;

FIG. 3 is a bottom perspective view of the tool from FIG. 1;

FIG. 4 is an exploded view of the plate assembly of the tool from FIG. 1;

FIGS. 5 and 6 are top plan isolated views of the tool, illustrated adjacent a pallet of cartons, showing the steps of detecting a stack of carton;

FIGS. 7 to 9 are side elevation of the tool, illustrated mounted to the end of the robotic arm and adjacent the pallet of cartons, showing the detection of a separator sheet;

FIG. 9A is a close up side elevation similar to FIG. 9, showing the tool during the detection of the separator sheet;

FIGS. 10 and 11 are top plan views similar to FIGS. 5 and 6, showing the insertion of the plate assembly between the separator sheet and the stack of cartons thereabove;

FIG. 12 is a side elevation similar to FIGS. 7 to 9 showing the tool so position relative to the pallet that the plate assembly is completely inserted between the separator sheet and the stack of cartons;

FIG. 13 is a side elevation similar to FIG. 12, showing the stack of cartons gripped by the tool and removed from the pallet; and

FIG. 14 is a perspective view showing the tool removing a separator sheet from the pallet using its sheet-removing assembly.

### DETAILED DESCRIPTION

In accordance with an illustrative embodiment, there is provided a tool for depalletizing piles of objects, wherein two adjacent piles of objects are separated by a separator sheet, the tool comprising:

a support assembly to be mounted at an end of a robotic arm;

a plate assembly mounted to the support assembly for insertion between a highest pile from the piles of objects and one of the separator sheets that is adjacent and below the highest pile; the plate assembly having a fixed portion and a tip provided at a distal end of the fixed portion; the plate assembly being movable between a detecting position, wherein an upward displacement of the tip is allowed relative to the fixed portion, and a depalletizing position, wherein the tip is immobilized relative to the fixed portion;

a plate sensor for detecting the displacement of the tip relative to the fixed portion and for generating a detection signal responsive to said displacement; and

a pressure assembly mounted to the support member so as to define a gripper with the plate assembly; the gripper being for receiving the highest pile of objects and for selectively applying pressure thereon;

whereby, in operation, when the plate assembly is in the detecting position, the detection signal is generated in response to the tip being displaced upwardly relative to the fixed portion by one of the separated sheets following a downward movement of the tool.

In accordance with another illustrative embodiment, there is provided a method for depalletizing piles of objects, wherein two adjacent piles of objects are separated by a separator sheet, the method comprising:

selecting the highest pile of objects as being a selected pile to depalletize;

approaching the selected pile from above thereof;

using a plate assembly having a fixed portion and a tip to detect the separator sheet adjacent and below the selected pile; the tip being movable between a detecting position, wherein an upward displacement of the tip is allowed relative to the fixed portion, and a depalletizing position, wherein the tip is immobilized relative to the fixed portion; the separator sheet being detected when the plate assembly is in the detecting position and the tip is displaced upwardly relative to the fixed portion while the plate assembly is moved downwardly;

inserting the plate assembly between the selected pile and the separator sheet adjacent and below the selected pile;

applying pressure onto the selected pile; and

removing the selected pile from piles of objects.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements.

Other objects, advantages and features will become more apparent upon reading of the following non-restrictive description of illustrative embodiments thereof, given by way of example only with reference to the accompanying drawings.

The word “object” for example in the expression “stack of objects” and “pile of objects” should not be construed in a limited way and is intended to include herein any package, container, solid composition of matter and substance that can be arrange in a stack or a pile.

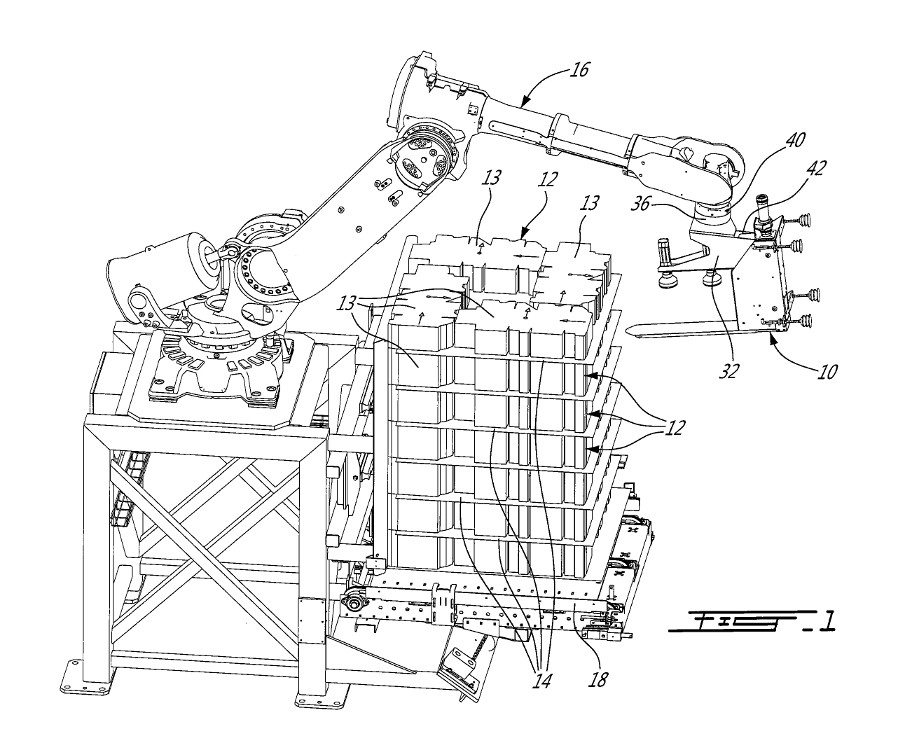

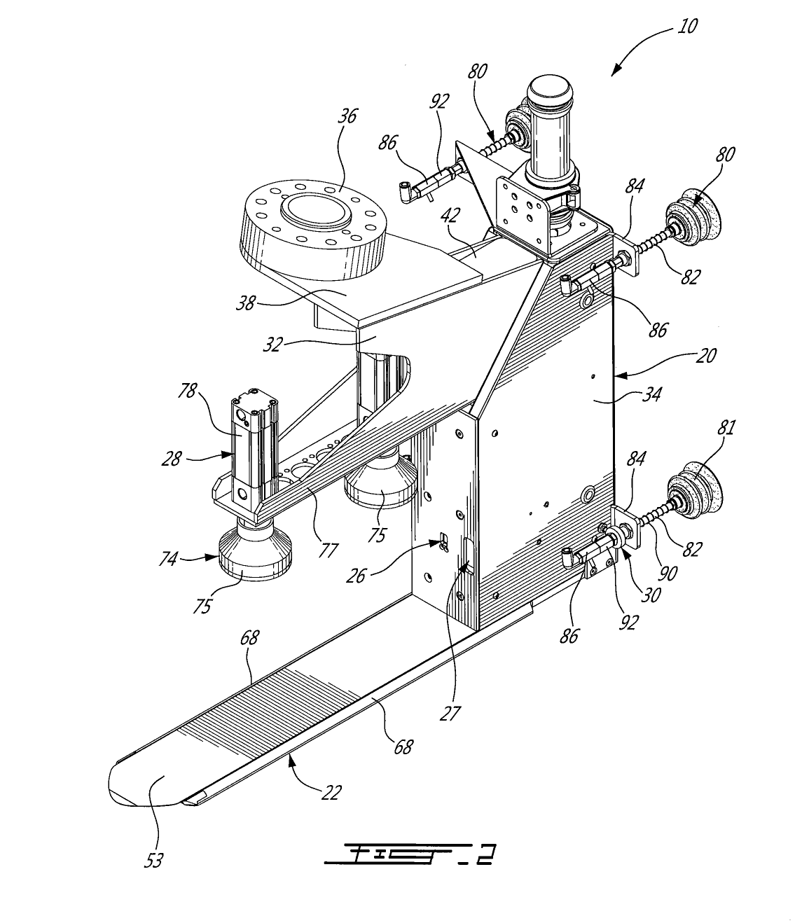

A tool 10 for depalletizing piles of objects 12 separated by sheets 14 according to an illustrative embodiment will be described with reference to FIGS. 1 to 3.

According to the illustrated embodiment, the objects are in the form of unfolded cartons. Each pile 12 includes four adjacent identical stacks 13 of cartons; each turned 90 degrees relative to the two adjacent stacks 13. As will become more apparent upon reading the following description, the tool 10 is not limited to depalletizing cartons that has been palletized according to the above-described pattern.

While the expression pile and stack are usually synonymous, the expression “stack” is used herein as a group of superimposed objects, while the expression “pile” is used herein to refer to one or more stacks that are laid out onto a separator sheet.

It is to be noted that the tool 10 is not limited to the application of depalletizing cartons and can be adapted to depalletize piles of other generally flat objects or more generally other objects arranged in piles.

As will be described furtherin and illustrated in FIG. 1, the tool 10 is configured to be mounted to a robotic arm 16, such as the six (6) axes robot, model IRB 6640, from ABB.

The piles of objects 12 are positioned at the end of a conveyor (not shown), on an unloading platform 18, on a pallet (not shown), or on any other structure or floor so as to be ready for depalletization. The robotic arm 16, with the tool 10 mounted thereto is positioned adjacent the unloading structure so that the piles 12 are within reach of the tool 10.

The tool 10 comprises a support assembly 20, a plate assembly 22 mounted to the support assembly 20 for insertion between one of the stacks 13 from the topmost pile 12 and the topmost separator sheets 14, a plate sensor 24 mounted to the plate assembly 22 for detecting the position of the plate assembly 22, stack and position detectors 26 and 27 both mounted to the support assembly 20, a pressure assembly 28 mounted to the support assembly 20, which defines a gripper with the plate assembly 22, and a sheet gripper 30 mounted to the support assembly 20.

The support assembly 20 is generally L-shaped and includes a beam (not shown), a girder 32 secured to the beam generally perpendicularly therefrom, and a generally rectangular casing 34.

As will be described furtherin in more detail, the support assembly 20 receives electrical and mechanical parts of some of the components of the tool 10 described hereinabove. The support assembly 20 also serves the function of supporting and positioning the components relative to one another. The support assembly 20 is made of steel, a composite material, or any other hard material and is assembled using soldering, fasteners (not shown), etc. The casing 34 is made of a metal such as aluminum or steel, a composite material, a polymer, or any hard material and is assembled using soldering, fasteners, etc.

The support assembly 20 further includes a fastening element 36 so secured to the girder 32 via a mounting plate 38 that the fastening element 36 is laterally biased from the support and plate assemblies 20 and 22. The fastening element 36 allows conventionally mounting the tool 10 to the flange 40 of the robotic arm 16.

As can be better seen in FIG. 1, the top portion 42 of the girder 32 is inclined relative to the upper plate 48 and lower plate element 42 of the plate assembly 22. It has been found that providing this inclination between the tool 10 and more specifically the plates 48 and 42 and the robot flange 40 allows minimizing singularities during operation of the tool 10. Since the concept of singularities is believed to be well-known in the art, it will not be described furtherin for concision purposes.

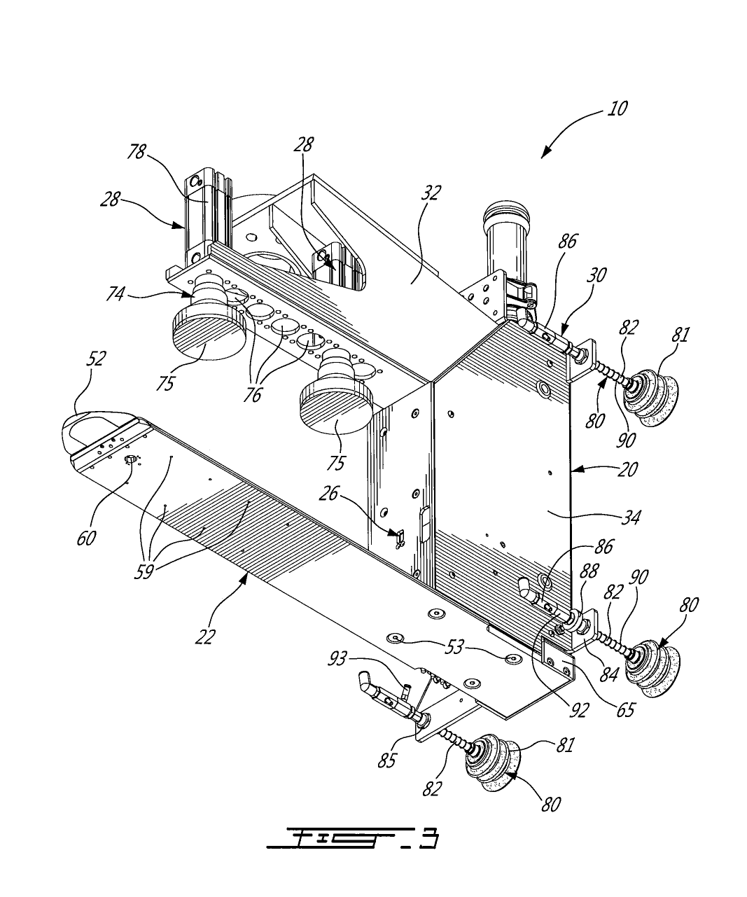

With reference now to FIGS. 2 to 4, the plate assembly 22 will now be described in more detail.

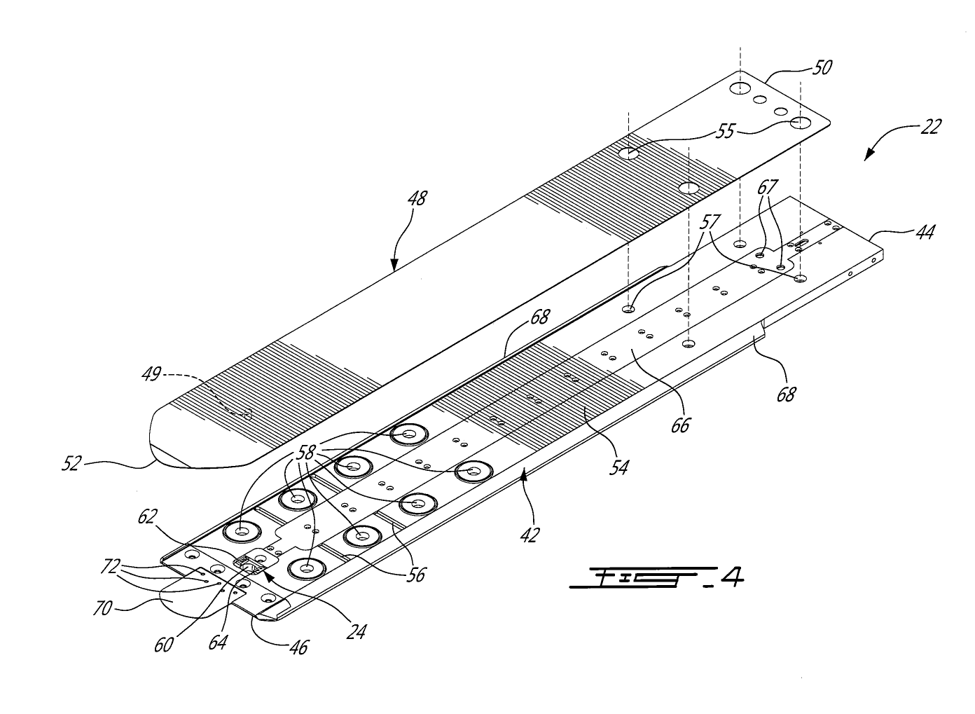

The plate assembly 22 includes a lower plate element 42, having proximate and distal longitudinal ends 44 and 46 and an upper flexible metal plate 48, having also proximate and distal longitudinal ends 50 and 52, mounted to the lower plate element 42. The upper plate 48 is secured to the lower plate element 42 via fasteners 53 (see on FIG. 3) mounted through apertures 55 and 57 in respectively the upper plate 48 and lower plate element 42. These apertures 55 and 57 are positioned adjacent the proximate ends 50 and 44 of respectively the upper plate 48 and lower plate assembly 42.

The upper plate 48 is forced in closed proximity onto the lower plate element 42 by the fasteners 53 resulting in a layered configuration of the plate 48 and plate assembly 42.

Both the lower plate element 42 and the upper plate 48 have generally rectangular shapes having similar sizes.

The upper plate 48 is made sufficiently thin so as to be flexible and a tilt movement of the upper plate 48 relative to the lower plate element 42 is allowed when a biasing force is exerted onto the upper plate 48, causing a partial separation of the upper plate 48 and lower plate element 42 adjacent their distal ends 52 and 46.

As it is can be better seen in FIG. 3, a portion of the upper plate 48 adjacent its distal end 52 extends beyond the distal end 46 of the lower plate element 42. This extending portion of the plate 48 will be referred to herein as the tip 52 of the plate 48.

The tip 52 of the upper plate 48 is rounded and bent about seven (7) degrees downwardly (or towards the lower plate element 42) resulting in an overall reverse ski-tip shape for the plate. As will be explained hereinbelow in more detail, bending the tip contribute to helping the plate assembly 22 collecting all the cartons in a stack 13, including the lowest one, i.e. the one adjacent the separator sheet 14 when the plate assembly 22 is inserted under a stack 13. The rounded shape of the end 52, which is more precisely oval, further contributes to successfully inserting the plate assembly 22 between a selected stack 13 and the sheet 14 below.

The upper plate 48 is made from a thin sheet of steel having a thickness of about 0.32 mm. According to other embodiments the upper sheet is made of other material and a different thickness that allows for the flexible properties when mounted to the lower plat element 42. Also, the upper plate 48 is not limited to having a rounded and/or bent distal end 52.

The upper face 53 of the upper plate 48 defines the object-receiving surface of the gripper defined with the pressure assembly 28.

The lower plate element 42 includes a generally flat rigid rectangular body 54 made of polished chromium plated 4140-HT (High Tensile) steel.

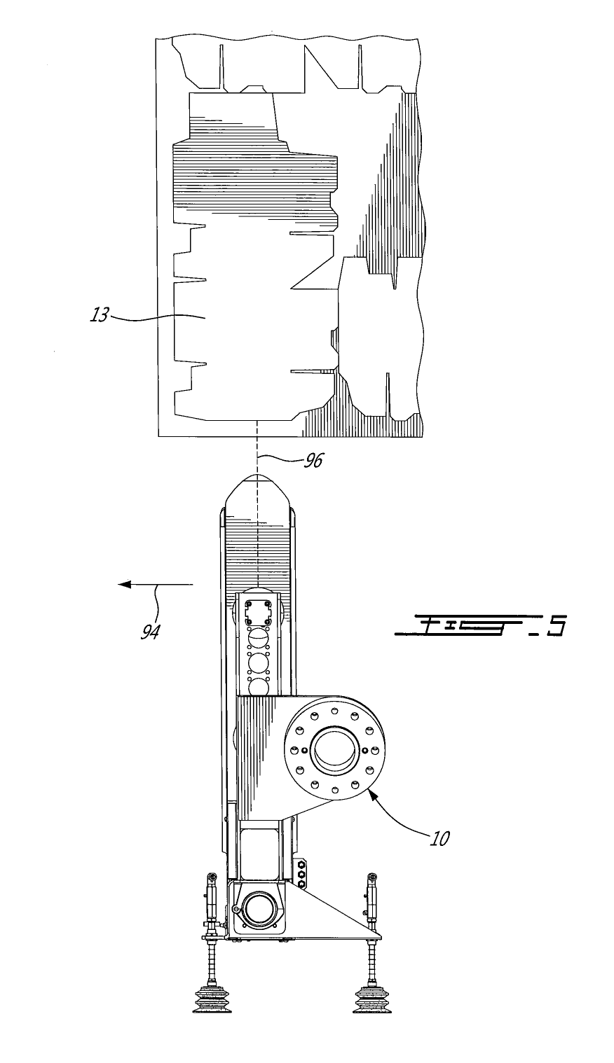

Transversal grooves 56 (two according to the illustrated embodiment) are provided in the body 54 to form air conduct with the upper plate 48 to allow passage for compressed air which allows to reduce pressure exerted by the stack of objects 13 onto the plate assembly 22 when the tool 10 is removed from under a stack 13. According to another embodiment, the number and geometry of the grooves 56 are different than those illustrated in FIG. 4. The configuration and position of the grooves 56 and the air pressure are adapted, for example, to the application.

The lower plate element 42 further includes biasing elements, in the form of magnets 58, which bias the plate 48 onto the lower plate element 42. The magnets 58 are mounted to the body 54 via fasteners 59. According to another embodiment, another fastening means, such as glue, snap fitting, or else, can be used.

The lower plate element 42 also receives parts of the plate sensor 24 including a hole 60 in the body 54 and optical fibres (not shown), having optical fibre transmitting and receiving ends 62-64. The optical fibres run from a laser and an optical detector both mounted to the back of the body 54 in a small casing 65 (both not shown), extend along the body 54 in a dedicated groove (not shown) under a protecting cap 66, and to the transmitting and receiving ends 62-64, which are located on opposite sides of the hole 60.

The dedicated groove and the cap 66 also house the air conducts that bring the compressed air in the grooves 56. The air inlets 67 are provided adjacent the distal end 44 of the body 54. Alternatively, they are mounted to the support assembly 20.

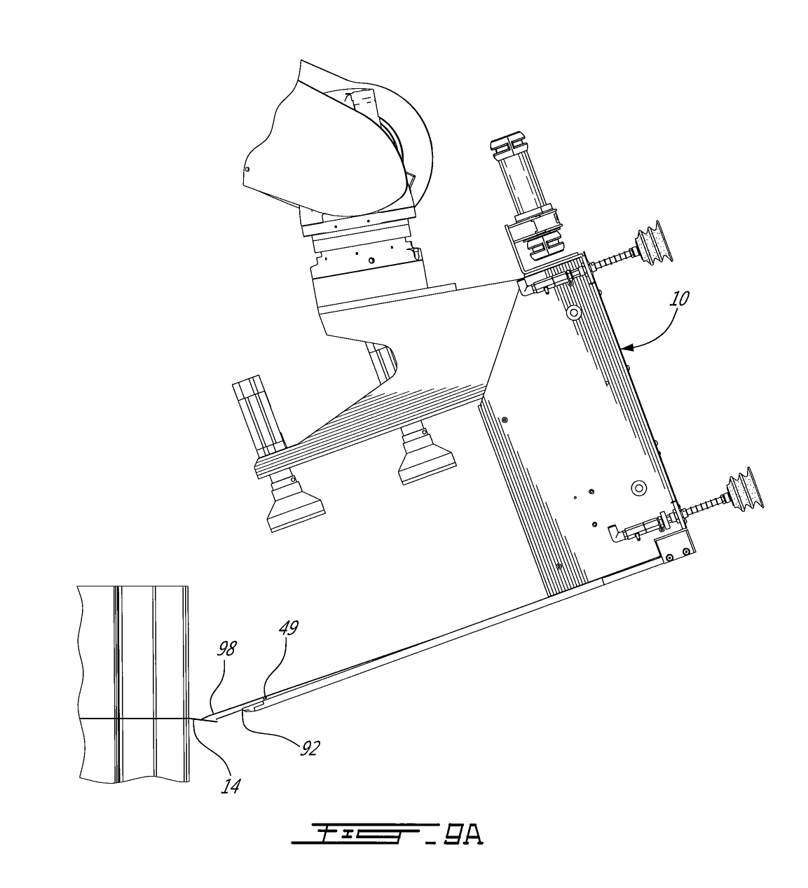

The upper plate 48 includes a small pin 49 (see FIG. 9A) soldered to the surface of the plate 48 facing the plate element 42 and so positioned thereon as to be registered with the hole 60 for insertion therein when the upper plate 48 is positioned onto the lower plate element 42.

According to another embodiment, the hole 60 is replaced by a recess or an aperture.

The plate assembly 22 further includes a third plate (not shown), that is secured to the lower plate element 42 between the body 54 and the upper plate 48. This third plate acts as a sealing joint for the compressed air circuit of the lower plate element 42.

In operation, the plate assembly 22 is movable between a detecting position, wherein an upward displacement of the tip 52 is allowed relative to the longitudinal portion, and a depalletizing position, wherein the tip 52 is immobilized relative to the lower plate element 42.

When the plate assembly 22 is in the detecting position, the tip 52 of the upper plate 48 is displaced upwardly relative to the lower plate element 42 following a downward movement of the tool 10 when the tip 52 contact for example a separator sheet 14. This cause the small pin on the upper plate 48 to exit the hole 60, which causes the detection of the laser light from the transmitting end and trough the receiving ends 62 by the optical detector.

The lower plate element 42 further includes removable rounded longitudinal edges 68 attached to the body 54 using fasteners (not shown).

The upper plate 48 is received within the edges 68. The width of the upper plate 48 is slightly less than the inner distance of the two edges 68 so as to allow passage for the compressed air onto the upper plate 48. For a similar reason, the edges 68 extend higher than the total height of the lower plate element 42 and upper plate 48 when they are layered in closed proximity.

The edges 68 also allow easing the insertion of the plate assembly 22 under a stack and to minimize markings by the plate assembly 22 onto the objects during said insertion.

According to further embodiments, the edges 68 are fixed and are for example integral with the body 54. They can also be omitted.

The lower plate element 42 finally includes a lower tip 70 attached to the body 54 at the distal end 46 thereof using fasteners 72. The lower tip 70 allows minimizing the possibility that the lower plate element 42 is wrongly inserted under the separator sheet 14 when the tool 10 moves towards the stack 13 after detecting the sheet 14. According to some embodiment of the depalletizing tool, the lower tip is omitted.

The plate assembly 22 according to the illustrated embodiment is easily mounted through four (4) fasteners and has its plate sensor 24 mounted thereon so as to facilitate the installation and removal thereof, for maintenance or changing.

With reference to FIGS. 2 and 3, the pressure assembly 28 includes two pressure pads 74, each one removably mounted to the girder 32 so as to be positioned generally perpendicular to the receiving surface 53. Each pressure pad 74 is provided with a contact head 75 adapted to the stack 13 to grip. More specifically, the pressure assemblies 28 are adapted for the geometry and dimension of the objects/stack to depalletize.

The girder 32 includes a pressure pads receiving portion 77 provided with a plurality of holes 76. The pressure pads 74 are removably mounted in the holes 76 and are secured through their cylinder 78 using shaft collars (not shown).

This mounting of the pressure pads 74 allows selecting and easily mounting pressure pads of appropriate configuration and sizes for a predetermined stack height. During operation, the pressure pads 74 are operated so that the contact heads 75 are moved towards the receiving surface 53 until they contact the object on the stack 13. Since pressure pads are believed to be well known in the art, they will not be described herein in further detail.

According to alternate embodiments, other means are provided for mounting the pressure pads 74 to the support assembly 20 and for their positioning relative the plate assembly 22 so as to define a gripper therewith.

Also, according to still other embodiments, the pressure pads 74 are replaced by another pressure assembly, such as a movable wall (not shown) mounted to the support assembly 20 and motorized for example by cylinders or another equivalent means.

The stack detector 26 is an optical detector, for example laser-based, that senses the presence of an object onto the plate assembly 22.

The position detector 27 is also a laser-based detector which sends a beam of light to detect the presence of a pile/stack and determine the distance thereof. As will become more apparent upon reading the description of the operation of the tool 10 hereinbelow, the detector 27 is provided to determine the lateral position of a stack 13 to depalletize and to evaluate the distance between said stack 13 and the tool 10.

According to another embodiment, one or both of the detectors 26 and 27 is based on ultrasounds, or else. Since such optical detectors are believed to be well-known in the art, they will not be described herein in more detail for concision purposes.

According to some embodiment, a single detector is used and configured to perform the functions of the detector 26 and 27 as described hereinabove.

According to still another embodiment, any one or both of the detectors 26 and 27 are indirectly mounted to the support assembly 20 via any one of the plate assembly 22, pressure assembly 28 and sheet gripper 30.

The sheet gripper 30 includes four (4) identical suction cup assemblies 80. Each assembly 80 includes a suction cup 81 slidably mounted to the casing 34 via a rod 82 that is inserted in a mounting bracket 84 or 85 which is secured to the casing 34. The mounting brackets 84 and 85 are configured and mounted to the casing 34 so as to position the respective suction cup 81 for movement along respective axes parallel to the upper plate 48 (and lower body 54).

Each suction cup 81 is connected to a vacuum pump 86 that operates the cup 80 when the tool 10 is positioned to pick up a separator sheet 14 as will be described furtherin in more detail.

The sheet gripper 30 further includes a position indicator 88 mounted to the rod 82 of one of the suction cup assemblies 80 to detect the contact of the suction cups 81 with a separator sheet 14. Since the operation of such a position indicator is believed to be well-known and the art, it will not be explained herein in more detail for concision purposes.

A biasing spring 90 is provided on each rod 82, between the cup 81 and the bracket 84 or 85, to bias the cup 81 to its default release position.

Finally, a spacer 92 is provided on each assembly 80 to allow sensing and reading the vacuum through a pressure transducer (not shown) mounted to the support assembly 20. This allows detecting when the sheet gripper 30 looses a separator sheet 14. The pressure transducer is connected to the spacer 92 through a hose (not shown) via a coupler 93.

Other characteristics and functions of the sheet gripper 30 will be described hereinbelow with reference to the operation of the tool 10.

According to another embodiment of the present tool for depalletizing, the sheet gripper 30 has a different number of cup assemblies then the tool 10.

The sheet gripper is not limited to the configuration and position illustrated in the drawings and described hereinabove.

According to other embodiments, the sheet gripper takes another form, such as a vacuum pad.

The tool 10 further includes a controller (not shown) or is configured for connection or coupling to a controller.

More specifically, the plate assembly 22, the pressure assembly 28, the sheet gripper 30 and the detectors 26 and 27 are coupled to the controller that is used to coordinate and trigger their operation.

According to some embodiments, and as it is conventionally known in the art, the tool 10 is controlled using the robotic arm 16 controller. According to such embodiments, the tool 10 comprises conventional ports and circuitry for connection and communication with the robotic arm 16.

Since the general programming and control of a tool to be mounted to the end of a conventional robotic arm 16 is believed to be well-known in the art, they will not be described herein in more detail for concision purposes.

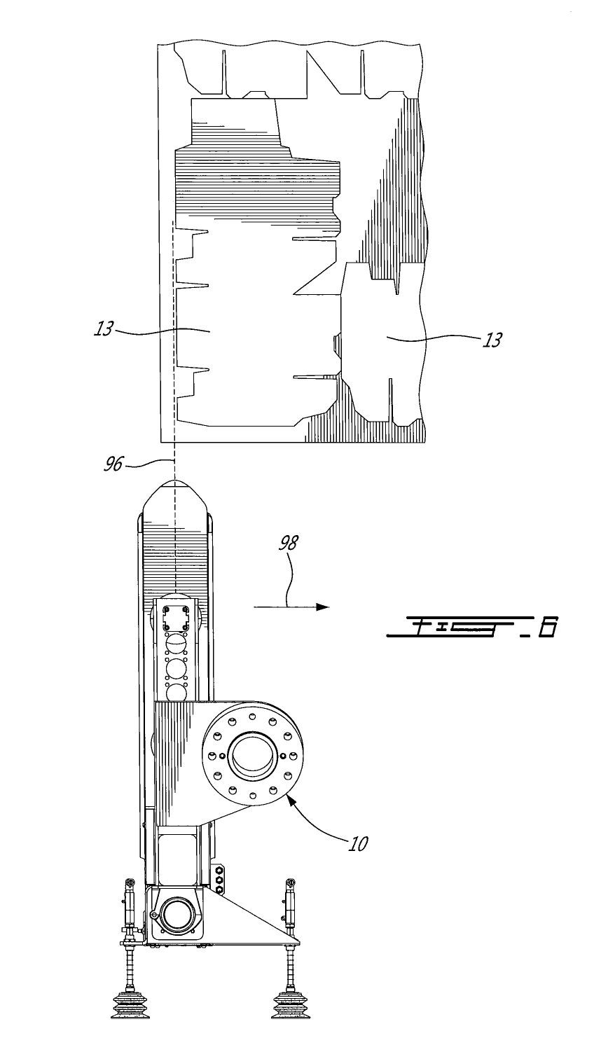

The operation of the tool 10 will now described with reference to FIGS. 5 to 14.

According to the first step, the tool 10 is positioned for depalletizing the next stack 13. According to the illustrated embodiment, the controller is programmed to make the tool 10 search the top of the pallet and for that purpose makes the tool 10 move from top to bottom. Then, once the top of the pallet is found, the controller makes the tool 10 moves from side to side (left to right) for scanning purposes to determine the center of a stack, knowing the width of an object (or product). The center of the stack will be used as the picking position by the tool 10. Of course, the controller can be configured with another depalletizing sequence, depending for example on the nature of the object to depalletize, the configuration of the pallet, the configuration of the tool and more specifically of the plate assembly 22, etc.

According to the illustrated embodiment, the position detector 27 is actuated and the robotic arm 16 is moved to the left (see arrow 94) until the detecting beam 96 of the detector 27 stops detecting objects. During the positioning steps, the tool 10 is aimed by the arm 16 so that the detector beam 96 is generally parallel to the layers of cartons in the stack 13 and therefore to the ground (not shown).

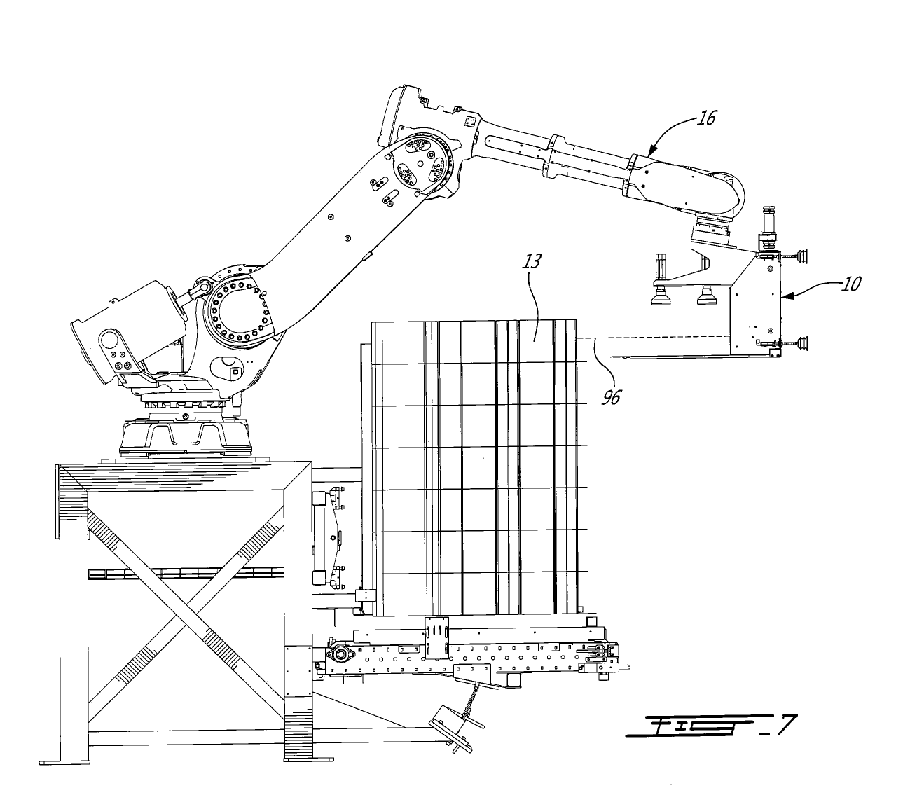

As illustrated in FIG. 6, when the end of the stack 13 is detected by the tool 10, the robotic arm 16 moves the tool 10 in the opposite direction (see arrow 98) until it is generally aligned with the center of the stack 13. For that purpose, the controller has been pre-programmed with the width of a stack 13. In the case wherein the controller is not programmed with such a data or has not access thereto, the robotic arm can be controlled with scanning movement that can be used by the controller to determine the width of the stack 13.

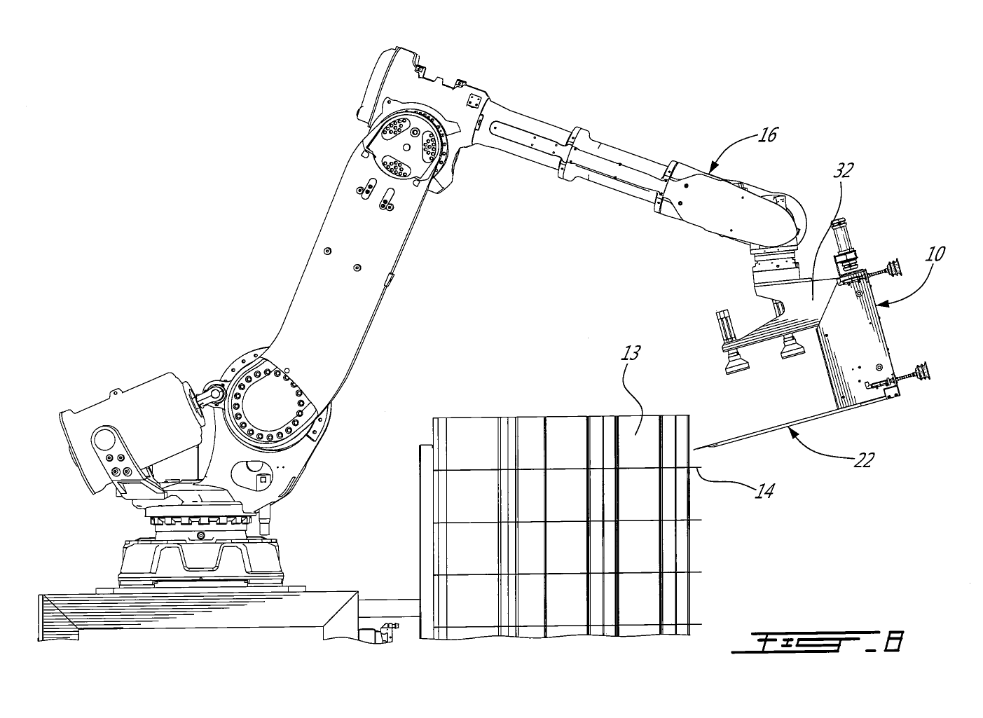

As illustrated in FIG. 7, the detector 27 is actuated and its reading used by the controller to move the robotic arm 16 at a predetermined distance from the stack 13 to begin the next step, which is the detection of the separator sheet 14. According to the illustrated embodiment, the predetermined distance is about 20 mm between the distal end 52 of the upper plate 48 and the stack 13.

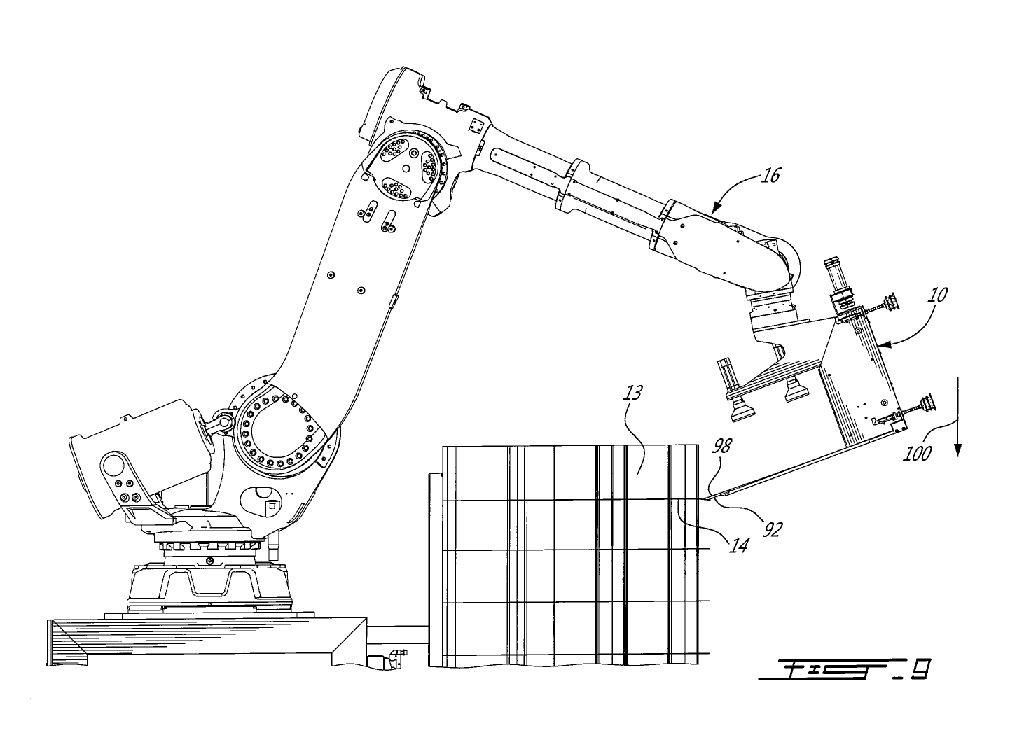

The tool 10 is then tilted to some degrees so that the tip 52 of the plate assembly 22 is lower than the distal end 50 thereof and of course is facing the stack 13 (see FIG. 8). It has been found that a tilt of about fifteen (15) degrees of the tool 10 allows minimizing markings on the objects by the tool 10 and improving sliding of the plate assembly 22 onto the cartons. Another angle might be found more suitable in another application, for example to depalletize another type of object.

It is to be noted that, up to the next step, no movement has been performed by the tool 10 and only the robotic arm 16 (not shown on FIG. 5) has moved.

The plate assembly 22 is then moved in the detecting position, thereby freeing the upper plate 48 as described hereinabove, and the robotic arm 16 moves downwardly (see arrow 100) until the tilting of the upper plate 48 releases the small pin 49 from the hole 60 and hence trigger the detection of the sheet 14 (see FIGS. 9 and 9A). The plate assembly 22 is moved to the depalletizing position. The stack detector 26 is activated and compressed air is sent through the plate assembly 22.

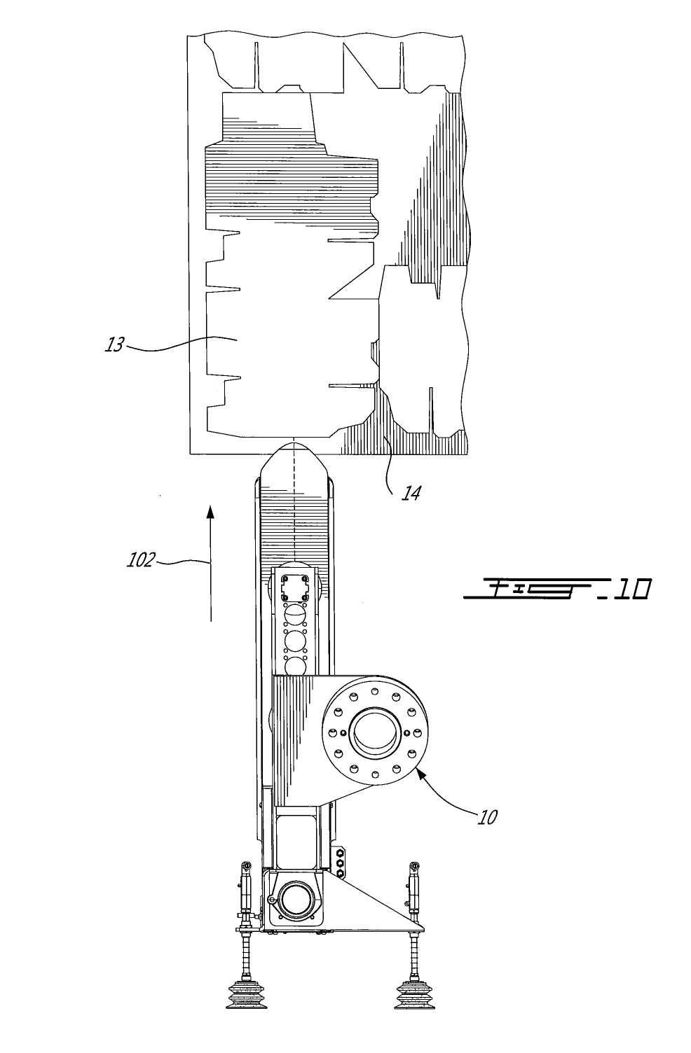

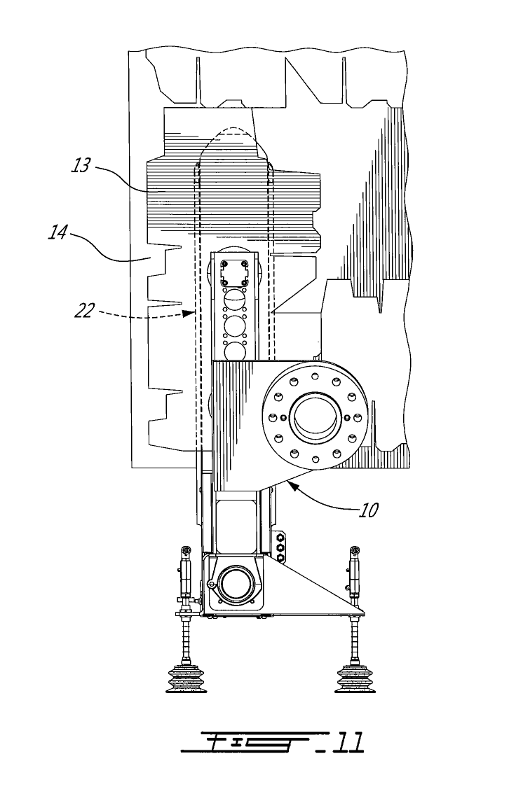

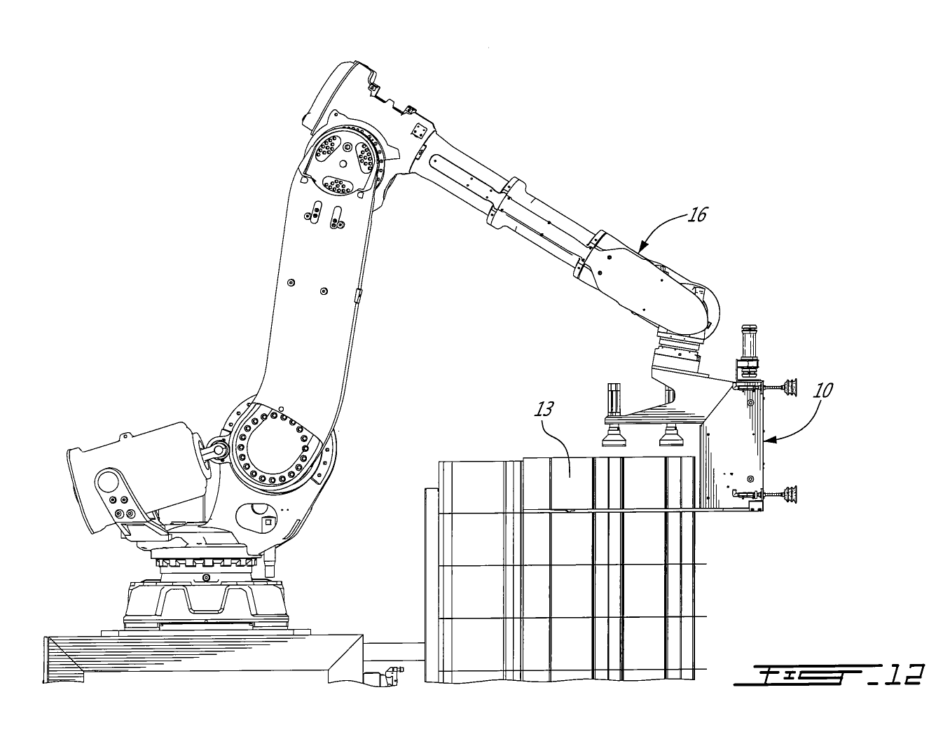

Still inclined, the tool 10 is moved forward by the arm 16 (see arrow 102 in FIG. 10), until the signal generated by the stack detector 26 and sent to the controller is indicative that the plate assembly 22 has sufficiently penetrated within the stack 13 (see FIGS. 11 and 12). While moving forward, the arm 16 gradually moves the tool 10 in a position where the upper plate 48 is parallel to the sheet 14.

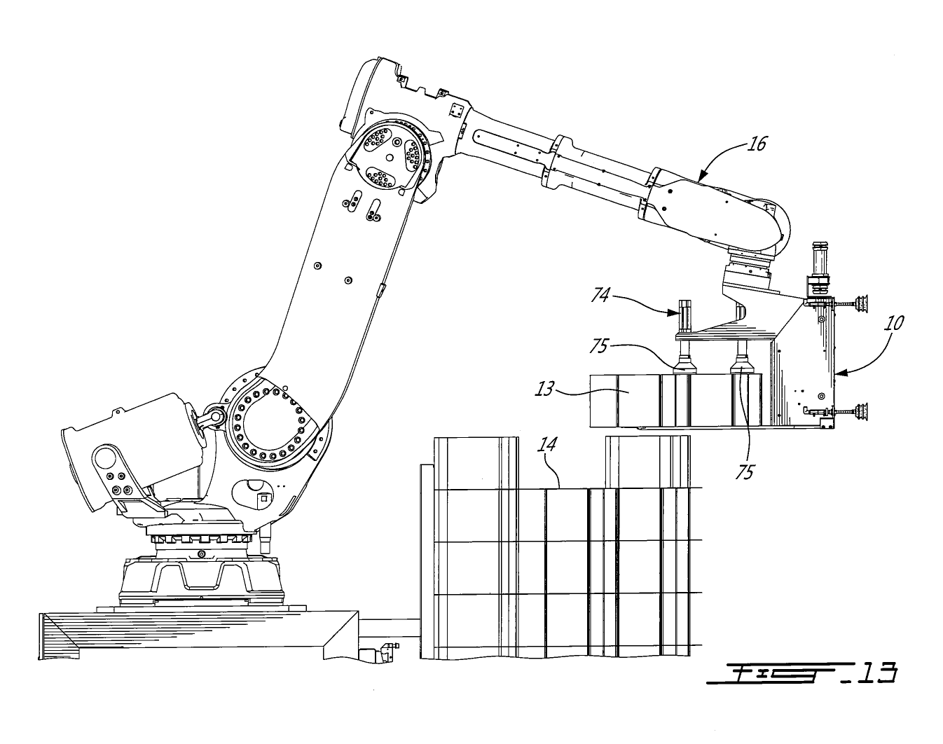

At this point, compressed air is stopped from being sent through the plate assembly 48. The pressure pads 74 are operated so that the contact heads 75 are moved towards the stack 13 until predetermined pressure is applied on the stack 13. Then the arm 16 raises the tool 10 with the stack 13 gripped thereby (see FIG. 13).

At a selected location within the reach of the robotic arm 16 (not shown), the stack 13 is depalletized by releasing the pressure pads 74, tilting the tool 10 and sending compressed air through the plate assembly 22.

The above steps are repeated for all stacks 13 from a pile 12.

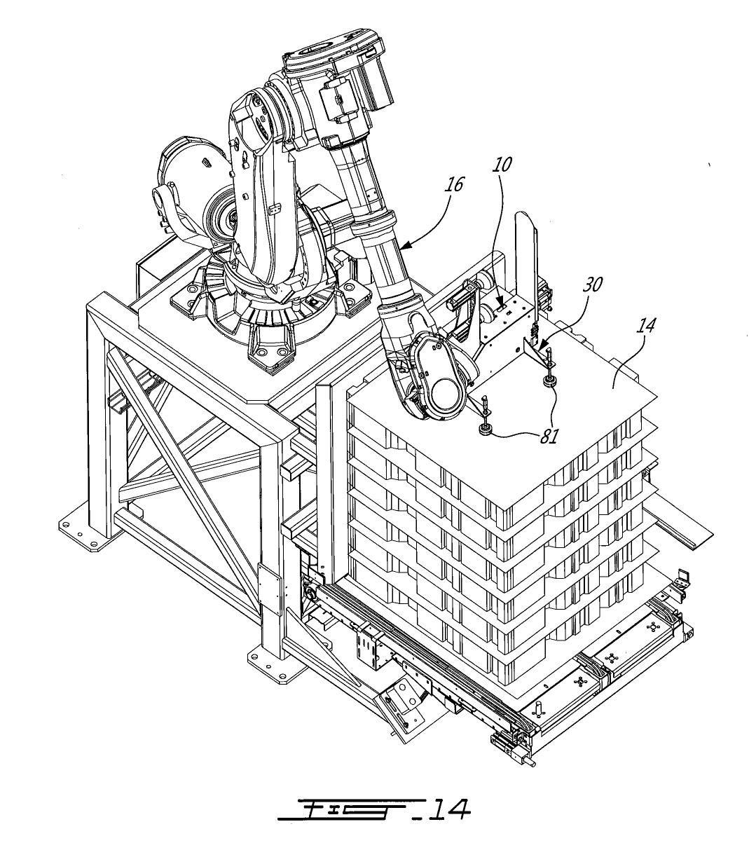

Turning now to FIG. 14, the arm 16 positions the tool 10 so that the suction cups 81 faces the separator sheet 14 which is then free of any stack 13. The arm 16 then slowly moves the tool 10 towards the sheet 14 until the position indicator 88 detects a contact between the suction cups 81 and the sheet 14. The vacuum pumps 86 are then activated so that the sheet 14 is taken by the gripper 30. The tool 10 is then moved to selected location where the sheet gripper 30 is released so as to release the sheet 14.

It is to be noted that many modifications could be made to the tool 10 described hereinabove, for example:
the mounting assembly is not limited to having the generally L-shaped described herein. Also, the shape of the casing can be different. The casing can also be omitted;
the mounting assembly can be configured so as to yield no inclination between the robotic arm mounting flange and the tool plates;
the plate sensor 24 or part thereof can be mounted to the support assembly 20;
the plate assembly is not limited to the above described and illustrated embodiments. For example, it is not limited to a reversed ski-like shape. It can have any shape having a tip at the end of a fixed portion. The rounded and bent shape of the tip 52 is not required for the operation of the tool 10;
according to other embodiments, the body 54 does not include grooves 56 for compressed air and no mechanism is provided to provide such compressed air to the assembly 22;
the plate sensor can take other form allowing for detecting the displacement of the tip relative to a fixed portion and for generating a detection signal in responsive to said displacement. For example, the optical fibre transmitting and receiving ends 62-64 are oriented upwardly towards the upper plate 48 so as to detect a change in signal when the plate 48 moves upwardly relative to the lower plate element 48 and therefore the transmitting and receiving ends 62-64;
another mechanism than the magnets can be used to bias the upper plate towards the lower plate assembly; and
the assembly of an upper plate mounted to a lower plate can be replace by a single plate including a fixed portion and a tip pivotably at the distal end of the fixed portion (not shown). The plate sensor might then be in the form, for example, of a contact switch in the hinge between the tip and the fixed portion.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention.

What is claimed is:

1. A tool for depalletizing piles of objects, wherein two adjacent piles of objects are separated by a separator sheet, the tool comprising:
a support assembly to be mounted at an end of a robotic arm;
a plate assembly mounted to the support assembly for insertion between a highest pile from the piles of objects and one of the separator sheets that is adjacent and below the highest pile; the plate assembly having a fixed portion and a tip provided at a distal end of the fixed portion; the plate assembly being movable between a detecting position, wherein an upward displacement of the tip is allowed relative to the fixed portion, and a depalletizing position, wherein the tip is immobilized relative to the fixed portion;
a plate sensor for detecting the displacement of the tip relative to the fixed portion and for generating a detection signal responsive to said displacement; and
a pressure assembly mounted to the support member so as to define a gripper with the plate assembly; the gripper being for receiving the highest pile of objects and for selectively applying pressure thereon;
whereby, in operation, when the plate assembly is in the detecting position, the detection signal is generated in response to the tip being displaced upwardly relative to the fixed portion by one of the separated sheets following a downward movement of the tool.

2. A tool as recited in claim 1, wherein the plate assembly includes a biasing element to force the plate assembly to its depalletizing position when no upward force is exerted on the tip relative to the fixed portion.

3. A tool as recited in claim 1, wherein the fixed portion of the plate assembly includes an object-receiving surface; the plate assembly being configured to generate compressed air on the object receiving surface.

4. A tool as recited in claim 1, wherein the tip of the plate assembly is at least one of bent and rounded.

5. A tool as recited in claim 1, wherein the plate assembly includes a lower plate element including the fixed portion and having a proximate end and a distal end and an upper flexible plate having a proximate end and a distal end; the tip being at the distal end of the upper plate; the upper flexible plate being mounted to the lower plate in close parallel proximity thereto and is secured adjacent the proximate end of the lower plate element to allow tilting of the distal end of the upper plate relative to the lower plate element.

6. A tool as recited in claim 5, wherein the upper plate and the lower plate element are generally rectangular in shape.

7. A tool as recited in claim 5, wherein the lower plate element includes a rigid body.

8. A tool as recited in claim 7, wherein the rigid body includes at least one groove defining with the upper plate a conduct for compressed air; the tool further comprising a compressed air inlet coupled to the grooves for receiving compressed air.

9. A tool as recited in claim 8, wherein the plate assembly further comprising a third plate mounted to the lower plate element thereon between the upper plate and the lower plate element for sealing the compressed air conduct.

10. A tool as recited in claim 5, wherein the upper plate includes metal; the lower plate element including at least one magnet to bias the upper plate towards the lower plate element.

11. A tool as recited in claim 5, wherein the upper plate includes a detecting element and the plate sensor includes a detector on the lower plate element responsive to the detecting element.

12. A tool as recited in claim 11, wherein the detecting element on the upper plate is a small pin on a surface of the upper plate facing the lower plate element; the detector on the lower plate element includes an aperture in the lower plate for receiving at least partially the small pin and detector transmitter and receiver on opposite sides of the aperture for detecting an obstruction of the aperture by the pin when the plate assembly is in the depalletizing position and freeing of the aperture by the pin when the plate assembly is in the detecting position.

13. A tool as recited in claim 1, wherein the plate assembly includes a biasing element to force the plate assembly to its depalletizing position when no upward force is exerted on the tip relative to the fixed portion.

14. A tool as recited in claim 1, wherein the pressure assembly includes at least one pressure pad.

15. A tool as recited in claim 14, wherein the at least one pressure pad is removably mounted to the support assembly.

16. A tool as recited in claim 1, further comprising a position detector mounted to the support assembly for sending a detecting beam towards a stack of objects and for receiving a reflected beam indicative of a distance of the stack of objects from the position detector.

17. A tool as recited in claim 16, wherein the position detector is laser-based.

18. A tool as recited in claim 1, further comprising a stack detector mounted to the support assembly or to the plate assembly for detecting the presence of the highest pile on the plate assembly.

19. A tool as recited in claim 1, wherein the plate assembly has an overall reverse ski shape.

20. A tool as recited in claim 1, wherein the support assembly includes a fastening element adapted to be mounted to the robotic arm.

21. A tool as recited in claim 20, wherein the fixed portion of the plate assembly includes an object-receiving surface; the fastening element being so inclined relative to the object-receiving surface as to minimize singularities during operation of the tool.

22. A tool as recited in claim 1, further comprising a sheet gripper mounted to the support assembly.

23. A tool as recited in claim 22, wherein the sheet gripper includes suction cup assemblies or a vacuum pad.

24. A tool as recited in claim 1, coupled to a controller for communicating the detection signal thereto; the controller being for selectively triggering the movement of the plate assembly between the detecting position and the depalletizing position in response to the detection signal and for triggering the applying of pressure onto the gripper.

25. A method for depalletizing piles of objects, wherein two adjacent piles of objects are separated by a separator sheet, the method comprising:
selecting the highest pile of objects as being a selected pile to depalletize;
approaching the selected pile from above thereof;
using a plate assembly having a fixed portion and a tip to detect the separator sheet adjacent and below the selected pile; the tip being movable between a detecting position, wherein an upward displacement of the tip is allowed relative to the fixed portion, and a depalletizing position, wherein the tip is immobilized relative to the fixed portion; the separator sheet being detected when the plate assembly is in the detecting position and the tip is displaced upwardly relative to the fixed portion while the plate assembly is moved downwardly;
inserting the plate assembly between the selected pile and the separator sheet adjacent and below the selected pile;
applying pressure onto the selected pile; and
removing the selected pile from piles of objects.

26. A method as recited in claim 25, further comprising finding the center of the selected pile prior to using a plate assembly having a fixed portion and a tip to detect the separator sheet adjacent and below the selected pile; wherein the plate assembly is inserted between the center of the selected pile and the separator sheet.

27. A method as recited in claim 25, further comprising removing the separator sheet after removing the selected pile from the piles of objects.

28. A method as recited in claim 25, wherein the tool is tilted prior to using a plate assembly having a fixed portion and a tip to detect the separator sheet adjacent and below the selected pile.

29. A method as recited in claim 25, further comprising sending compressed air onto the plate assembly prior to inserting the plate assembly between the selected pile and the separator sheet adjacent and below the selected pile.

30. A method as recited in claim 25, wherein the objects are unfolded cartons.

31. A method as recited in claim 25, wherein each pile of objects include at least one stack of object; said selecting the highest pile further includes selecting one of the at least one stack; the selected pile being said one of the at least one stack.
